(19) United States
(12) Patent Application Publication
(10) Pub. No.: US 2021/0230447 A1
(43) Pub. Date: Jul. 29, 2021

(54) Two-component coating composition, method for homogeneously mixing a curing component into a binder component, and use of nano pigments for providing a marker color to a curing component

(71) Applicant: Akzo Nobel Coatings International B.V., Amhem (NL)

(72) Inventor: Dirk Seeger, Oldenburg (DE)

(21) Appl. No.: 17/051,096

(22) PCT Filed: Apr. 29, 2018
(86) PCT No.: PCT/EP2019/060850

§ 371 Date: Oct. 27, 2020

(30) Foreign Application Priority Data
May 3, 2018 (EP) 18170650.8

(51) Int. Cl. C09D 175/04

(52) U.S. Cl. CPC C09D 175/04

(57) ABSTRACT

The present disclosure relates to a two-component coating composition comprising: i) a binder component comprising an isocyanate-curable binder polymer; and ii) a curing component comprising an isocyanate-functional curing agent and a color pigment having a D50 particle size in the range of from 10 to 200 nm and a D95 particle size in the range of from 30 to 300 nm, wherein the D50 and D95 particle size are measured by laser diffraction according to ISO 13320 using the Mie theory, wherein the curing component is free of any further color pigment. The disclosure further relates to a method for homogeneously mixing a curing component comprising an isocyanate-functional curing agent colored with nanopigments into a binder component, and to use of nanopigments for providing a marker color to a curing component comprising an isocyanate-functional curing agent.

### FIELD OF THE INVENTION

The present invention relates to a two-component coating composition comprising a binder component comprising an isocyanate-curable binder polymer, and a curing component comprising an isocyanate-functional curing agent and a color pigment. The invention further relates to a method for homogeneously mixing a curing component comprising such colored isocyanate-functional curing agent into a binder component, and to use of nanopigments for providing a marker color to a curing component comprising an isocyanate-functional curing agent.

### BACKGROUND OF THE INVENTION

Coating compositions with isocyanate-curable binder resins such as for example polyurethanes, polyurea, polyols, polyamines, polyesters, polyethers, or polyacrylates are typically provided as two-component compositions. A binder component comprising the isocyanate-curable binder polymer and a curing component comprising an isocyanate-functional curing agent are separately provided and mixed shortly before application of the coating composition. In order to facilitate homogeneous mixing of the curing component into the binder component (also referred to as base component), color pigment may be added to the curing component. Thus, visualization of the degree of mixing of the curing component into the binder component is achieved.

Isocyanate-functional curing components typically show insufficient thixotropic behavior to avoid sedimentation (also referred to as settling) of solid color pigments. Sedimentation of color pigments may cause uneven distribution of the color pigment throughout the curing component. Unless the curing component is sufficiently stirred before adding the curing component to the binder component, the amount of color pigment added to the coating composition upon mixing the two components may vary between batches. As a result, undesired variations in color occur.

### SUMMARY OF THE INVENTION

It has now been found that by using color pigments of a specific particle size in curing components for isocyanate-curable binder systems, variations in color can be avoided whilst still achieving visualization of the degree of mixing.

Accordingly, the invention provides in a first aspect a two-component coating composition comprising:
i) a binder component comprising an isocyanate-curable binder polymer; and
ii) a curing component comprising an isocyanate-functional curing agent and a color pigment having a D50 particle size in the range of from 10 to 200 nm and a D95 particle size in the range of from 30 to 300 nm, wherein the D50 and D95 particle size are measured by laser diffraction according to ISO 13320 using the Mie theory,

wherein the curing component is free of any further color pigment.

It is an advantage of the two-component composition according to the invention that there is no need to formulate the curing component such that it shows thixotropic behavior. Also in a non-thixotropic curing agent, the color pigment is stably dispersed in the curing component. Thus, the amount of color pigment added to the binder component is the same, each time the two components are mixed in the desired ratio. Thus, the invention provides a two-component coating composition wherein the homogeneity of mixing of the two components can be controlled by visualizing the degree of mixing of the curing component into the binder or base component without causing undesired color variation between different batches.

Thus, in a second aspect, the invention provides a method for homogeneously mixing a curing component comprising an isocyanate-functional curing agent into a binder component comprising an isocyanate-curable binder polymer, comprising:
providing a curing component as hereinbefore defined;
providing a binder component as hereinbefore defined;
adding the curing component to the binder component to obtain a mixture; and
stirring until a homogeneous color of the mixture is obtained.

In a third aspect, the invention provides use of a color pigment as hereinbefore defined for providing a marker color to a curing component comprising an isocyanate-functional curing agent.

### DETAILED DESCRIPTION OF THE INVENTION

The two-component coating composition according to the invention comprises i) a binder component comprising an isocyanate-curable binder polymer; and ii) a curing component comprising an isocyanate-functional curing agent and a color pigment.

The binder component comprises an isocyanate-curable binder polymer. Such binder polymers are well-known in the art and include polyols, polyamines, and polyesters, polyethers, polyurethanes polyacrylates, and polyureas with isocyanates-curable terminal and/or pending functional groups, typically hydroxy- and/or amine groups.

The binder component may comprise further components common for base components for coating compositions, such as solvents, extender pigments (fillers), color pigments, and additives.

The curing component comprises an isocyanate-functional curing agent. Any isocyanate-functional curing agent known to be suitable for curing the isocyanate-curable binder polymer in the binder component may be used. Suitable isocyanate-functional curing agents are polyisocyanates having on average more than one isocyanate group per molecule. The polyisocyanate may be aliphatic or aromatic. Di-isocyanates, and dimers or trimers of di-isocyanates, such as uretdiones, tri-isocyanurates, or biurets, are preferred. The polyisocyanate may for example be hexamethylene di-isocyanate, octamethylene di-isocyanate, decamethylene di-isocyanate, dodecamethylene di-isocyanate, tetradecamethylene di-isocyanate, trimethylhexane di-isocyanate, tetramethylhexane di-isocyanate, or any other C2-C18 alkyl di-isocyanate, isophorone di-isocyanate (IPDI), 2-isocyanatopropylcyclohexyl isocyanate, dicyclohexylmethane 2,4′-di-isocyanate, dicyclohexylmethane 4,4′-di-isocyanate, 1,4- or 1,3-bis(isocyanatomethyl)cyclohexane, 1,4- or 1,3- or 1,2-di-isocyanatocyclohexane, 2,4- or 2,6-di-isocyanato-1-methylcyclohexane, any alkylated derivative thereof, a dimer or trimer thereof, or a mixture of two or more thereof. Uretdiones, tri-isocyanurates, or biurets are particularly preferred. Preferred polyisocyanates are hexamethylene di-isocyanate, isophorone di-isocyanate, mixtures thereof, and its various trimers and dimers. The polyisocyanate may be a modified polyisocyanate, such as for example a polyether-modified and/or polyester-modified polyisocyanate. The isocyanate groups in these components may be free or may be blocked with known blocking agents. Preferably the isocyanate groups are non-blocked, i.e. free, isocyanate groups.

Particularly preferred is a polyisocyanate containing a biuret group. The polyisocyanate containing a biuret group is preferably an aliphatic polyisocyanate. The aliphatic polyisocyanate containing a biuret group may be obtained from 1,6-hexamethylene di-isocyanate (HDI), 1,3-cyclohexyl di-isocyanate, 1,4-cyclohexyl di-isocyanate (CHDI), diphenylmethane di-isocyanates, 2,2,4- and/or 2,4,4-trimethyl-1,6-hexamethylene di-isocyanate, dodecamethylene di-isocyanate, isophorone di-isocyanate (IPDI), by oligomerization with biuret formation. Three molecules of HDI react for example with one molecule of water, with elimination of one molecule of carbon dioxide, to yield an HDI biuret.

Particularly preferred is a biuret of an aliphatic polyisocyanate based on isophorone di-isocyanate and/or hexamethylene di-isocyanate, more in particular the biuret of hexamethylene di-isocyanate.

The curing component comprises a color pigment having a D50 particle size in the range of from 10 to 200 nm and a D95 particle size in the range of from 30 to 300 nm. Preferably, the color pigment has a D50 particle size in the range of from 20 to 150 nm and a D95 particle size in the range of from 50 to 200 nm.

Reference herein to the D50 is to the volume median of the particles as measured by laser diffraction according to ISO 13320, using the Mie theory. Reference herein to the D95 is to the particle size at which 95 volume % of the particles has a smaller size and 5 volume % has a larger size as measured by laser diffraction according to ISO 13320, using the Mie theory.

Color pigments with suitable particle sizes are known in the art and commercially available, for examples as Hostatint A 100-ST (ex. Clariant).

The color pigment is a solid color pigment. The pigment may be an inorganic or an organic pigment. Examples of organic color pigments include metal complexes of phthalocyanine, quinacridone, perylene pigments, Naphthol Red, and nickel-azo complexes. Examples of inorganic color pigments include iron oxides and other metal oxides.

Solid color pigments are typically provided as a pigment paste, i.e. a viscous dispersion of pigment in an organic solvent.

The curing component preferably comprises the isocyanate-functional curing agent in an amount in the range of from 20 to 100 wt %, more preferably in the range of from 50 to 100 wt %, based on the total weight of the curing component excluding the weight of the color pigment.

The color pigment may be present in any suitable amount, preferably in the range of from 0.001 to 0.5 wt %, more preferably of from 0.005 to 0.1 wt %. In order to avoid settling of color pigments, the curing component is free of any further color pigment, i.e. free of any color pigment other than color pigments with a particle size as specified above.

The curing component may comprise further compounds, i.e. other than the isocyanate-functional curing agent and the color pigment, for example solvent or additives such as defoamers, adhesion promoters, or wetting agents. Preferably, the curing component is free of rheology modifying additives, often referred to as thixotropes.

Preferably, the binder component comprises solid color pigments and/or white pigment (typically titanium dioxide). The color pigments and white pigments in the binder component do not need to be nanopigments, i.e. pigments with a D50 far below 1 μm, since binder components of two-component coating compositions are typically formulated such that they show thixotropic behavior. The thixotropic nature of the binder component prevents color pigment to settle and thus provides storage stability.

The coating composition according to the invention can suitably be applied as protective coating on substrates such as metal, plastic and composite (fiber-reinforced plastic) substrates. The method according to the second aspect of the invention is a method for homogeneously mixing a curing component comprising an isocyanate-functional curing agent into a binder component comprising an isocyanate-curable binder polymer. The method comprises providing a curing component as hereinbefore defined, i.e. a curing component comprising an isocyanate-functional curing agent and a color pigment having a particle size as hereinbefore defined. The method further comprises providing a binder component as hereinbefore defined, i.e. a binder component comprising an isocyanate-curable binder polymer. The curing component is added to the binder component to obtain a mixture and the mixture is stirred until a homogeneous color of the mixture is obtained.

Any preferred features for the curing component or the binder component of the two-component coating composition according to the first aspect of the invention, also apply for the curing component or the binder component provided in the method according to the second aspect of the invention.

In a final aspect, the invention provides use of a color pigment with a particle size as defined hereinabove, i.e. having a D50 in the range of from 10 to 200 nm and a D95 in the range of from 30 to 300 nm, for providing a marker color to a curing component comprising an isocyanate-functional curing agent. Reference herein to a marker color is to a color that visualizes the degree of mixing of a colored component into another component. Preferably, the color pigment has a D50 particle size in the range of from 20 to 150 nm and a D95 particle size in the range of from 50 to 200 nm.

### EXAMPLES

The invention will be further illustrated by means of the following non-limiting examples.

Preparation of Curing Components with Solid Color Pigment

Curing components were prepared by mixing an isocyanate-functional curing agent and a pigment paste (0.1 wt % pigment paste based on the total weight of the curing component). The isocyanate-functional curing agents used are listed in Table 1. The pigment pastes used are given in Table 2.

TABLE 1
Isocyanate-functional curing agents used

| Commercial name | Isocyanate-functional curing agent |
|---|---|
| Desmodur N100 | hexamethylene di-isocyanate biuret |
| Desmodur N3600 | tri-isocyanurate of hexamethylene |
| | di-isocyanate |
| Desmodur N3200 | hexamethylene di-isocyanate biuret |

TABLE 2
Pigment pastes used

| Commercial name | Color pigment | D50 (nm) | D95 (nm) | Pigment conc. (% w/w) |
|---|---|---|---|---|
| Hostatint Blue A-BTR | Pigment Blue 15:1 | <115 | <180 | 7 |
| Hostatint Red A-P2Y | Pigment Red 179 | <30 | <120 | 15 |
| Hostatint Green A-GMY | Pigment Blue 15:4/Pigment | <100 | <180 | 15 |
| | Yellow 150 | | | |
| Hostatint Blue A-BTG | Pigment Blue 15:4 | <100 | <180 | 15 |
| Hostatint Black A-NY | Pigment Black 7 | <100 | <100 | 15 |
| Hostatint Pink A-EB | Pigment Red 122 | <65 | <150 | 7 |
| Hostatint Black A-NB | Pigment Black 7 | <150 | <300 | 25 |
| Hostatint Yellow A-N4G | Pigment Yellow 150 | <100 | <150 | 15 |
| Hostatint Green A-GMB | Pigment Blue 15:4/Pigment | <100 | <180 | 15 |
| | Yellow 150 | | | |
| NEFA ® PUR black 7 | Pigment Black 7 | | 15,000* | 18 |
| Vocaplast-P black (S-6533) | Pigment Black 7 | | 10,000* | 25 |

*determined according to ISO 1524.

Stability Test

The curing components were stored in closed glass vials at 20° C. The storage stability of the curing components was determined by assessing whether the pigments settled or remained homogeneously dispersed in the curing component at several time intervals. The storage stability was rated from 1 to 10 (not stable to very stable) as follows:

1 Sedimentation of pigment within one day

2 No sedimentation after 1 day; some sedimentation after 1 week

3 No sedimentation after 1 week; some sedimentation after 2 weeks

4 No sedimentation after 2 weeks; some sedimentation after 1 month

5 No sedimentation after 1 month; some sedimentation after 2 months

6 No sedimentation after 2 months; some sedimentation after 3 months

7 No sedimentation after 3 months; some sedimentation after 6 months

8 No sedimentation after 6 months; some sedimentation after 12 months

9 No sedimentation after 12 months; slight sedimentation after 18 months

10 No sedimentation after 18 months

In Table 3 the results of the stability test are shown for all curing components. Curing components 1 to 16 are curing components for use in the coating composition and method according to the invention. Curing components 17 to 20 are for comparison.

TABLE 3
Storage stability of curing components

| | | Curing | Stability |
|---|---|---|---|
| No. | Pigment paste | agent | rating |
| 1 | Hostatint Blue A-BTR | N100 | 10 |
| 2 | Hostatint Blue A-BTR | N3600 | 10 |
| 3 | Hostatint Red A-P2Y | N100 | 10 |
| 4 | Hostatint Red A-P2Y | N3600 | 9 |
| 5 | Hostatint Green A-GMY | N100 | 10 |
| 6 | Hostatint Green A-GMY | N3600 | 10 |
| 7 | Hostatint Blue A-BTG | N100 | 10 |
| 8 | Hostatint Blue A-BTG | N3600 | 10 |
| 9 | Hostatint Black A-NY | N100 | 9 |
| 10 | Hostatint Black A-NY | N3600 | 10 |
| 11 | Hostatint Yellow A-N4G | N100 | 10 |
| 12 | Hostatint Yellow A-N4G | N3600 | 10 |
| 13 | Hostatint Yellow A-N4G | N100 | 10 |
| 14 | Hostatint Yellow A-N4G | N3600 | 10 |
| 15 | Hostatint Green A-GMB | N100 | 10 |
| 16 | Hostatint Green A-GMB | N3600 | 10 |
| 17 | NEFA ® PUR black 7 | N100 | 1 |
| 18 | NEFA ® FUR black 7 | N3200 | 1 |
| 19 | Vocaplast-P black S-6533 | N100 | 1 |
| 20 | Vocaplast-P black S-6533 | N3200 | 1 |

1. A two-component coating composition comprising:
i) a binder component comprising an isocyanate-curable binder polymer; and
ii) a curing component comprising an isocyanate-functional curing agent and a color pigment having a D50 particle size in the range of from 10 to 200 nm and a D95 particle size in the range of from 30 to 300 nm, wherein the D50 and D95 particle size are measured by laser diffraction according to ISO 13320 using the Mie theory,
wherein the curing component is free of any further color pigment.

2. The two-component coating composition according to claim 1, wherein the curing component comprises a color pigment having a D50 particle size in the range of from 20 to 150 nm and a D95 particle size in the range of from 50 to 200 nm.

3. The two-component coating composition according to claim 1, wherein the curing component comprises from 0.001 to 0.5 wt % of the color pigment, based on the total weight of the curing component.

4. The two-component coating composition according to claim 1, wherein the binder component comprises one or more color pigments.

5. A method for homogeneously mixing a curing component comprising an isocyanate-functional curing agent into a binder component comprising an isocyanate-curable binder polymer, comprising:
providing a curing component as defined in claim 1;
providing a binder component as defined in claim 1;
adding the curing component to the binder component to obtain a mixture; and
stirring until a homogeneous color of the mixture is obtained.

6. (canceled)

7. A method for providing a marker color to a curing component comprising adding the color pigment of claim 1 to a curing component comprising an isocyanate-functional curing agent.

8. The two-component coating composition according to claim 1, wherein the curing component comprises from 0.005 to 0.1 wt % of the color pigment, based on the total weight of the curing component.

9. The two-component coating composition according to claim 2, wherein the curing component comprises from 0.001 to 0.5 wt % of the color pigment based on the total weight of the curing component.

10. The two-component coating composition according to claim 2, wherein the curing component comprises from 0.005 to 0.1 wt % of the color pigment based on the total weight of the curing component.

11. The two-component coating composition according to claim 2, wherein the binder component comprises one or more color pigments.

12. The two-component coating composition according to claim 3, wherein the binder component comprises one or more color pigments.
